(19) United States
(12) Patent Application Publication
(10) Pub. No.: US 2021/0389147 A1
(43) Pub. Date: Dec. 16, 2021

(54) VEHICLE ROUTE GUIDING SYSTEM USING PERSONAL MOBILITY AND ROUTE GUIDING METHOD USING THE SAME

(71) Applicants: Hyundai Motor Company, Seoul (KR); Kia Motors Corporation, Seoul (KR)

(72) Inventor: Jae Joong Kim, Seoul (KR)

(21) Appl. No.: 17/094,058

(22) Filed: Nov. 10, 2020

(30) Foreign Application Priority Data
Jun. 12, 2020 (KR) 10-2020-0071323

(51) Int. Cl. G01C 21/34; G01C 21/36

(52) U.S. Cl. CPC G01C 21/3484; G01C 21/3641; G01C 21/3423; G01C 21/3492

(57) ABSTRACT

The present disclosure relates to a route guiding system using personal mobility. The system includes a communication device for communicating with an interface terminal of a user of a vehicle, and a route guiding server that provides guidance a personal mobility-linked route based on information on traffic along a travel route from a current location to a final destination, a time required for travel based on the traffic information, and a personal mobility rental probability when information about the current location and the final destination of the vehicle is received from the interface terminal.

### CROSS-REFERENCE TO RELATED APPLICATION

This application claims the benefit of priority to Korean Patent Application No. 10-2020-0071323, filed on Jun. 12, 2020, the entire contents of which are incorporated herein by reference.

### TECHNICAL FIELD

The present disclosure relates to a vehicle route guiding system and a route guiding method using the same, and more particularly to, a vehicle route guiding system using personal mobility and a route guiding method using the same.

### BACKGROUND

In an operation of a vehicle, a navigation service for setting a destination and searching for and providing an optimal route using a global positioning system (GPS) is becoming common. The navigation service increases a cost, a time, and the like to allow a user to search for various desired routes and to select a desired route, thereby satisfying needs of the user.

In one example, recently, personal mobility, which is electric means of transportation commonly referred to as a kick board or a quick board, has been widely used. The personal mobility is rapidly emerging as new alternative means of transportation due to being moved easily and quickly over a short distance or a zone with severe vehicle congestion. Accordingly, there is a need for a service method capable of linking the personal mobility with existing means of transportation.

### SUMMARY

The present disclosure provides a system and a method capable of providing navigation route guidance through linkage with personal mobility. Another aspect of the present disclosure provides a vehicle route guiding system and a route guiding method using the same capable of searching for mobility information and communicating with a mobility user to use personal mobility.

Another aspect of the present disclosure provides a vehicle route guiding system using personal mobility and a route guiding method using the same that propose a route for rapidly moving through a congested section. Another aspect of the present disclosure provides a vehicle route guiding system and a route guiding method using the same capable of moving personal mobility to an intermediate destination linkable with a vehicle.

The technical problems to be solved by the present inventive concept are not limited to the aforementioned problems, and any other technical problems not mentioned herein will be clearly understood from the following description by those skilled in the art to which the present disclosure pertains.

According to an aspect of the present disclosure, a system for guiding a route using a personal mobility may include a communication device configured to communicate with an interface terminal of a user of a vehicle, and a route guiding server configured to guide a personal mobility-linked route based on information on traffic along a travel route from a current location to a final destination, a time required for travel based on the traffic information, and a personal mobility rental probability when information about the current location and the final destination of the vehicle is received from the interface terminal.

In one implementation, the route guiding server may be configured to determine whether the final destination is within a service region where the personal mobility is able to be used, and guide the personal mobility-linked route when the final destination is within the service region. In addition, the route guiding server may be configured to determine a smooth section where the vehicle travels smoothly and a congested section where the travel of the vehicle is stagnant of the travel route based on the traffic information, and guide the personal mobility-linked route when the congested section is a general road.

The route guiding server may be configured to guide the personal mobility-linked route when the congested section exists after the smooth section on the travel route. In addition, the route guiding server may be configured to guide the personal mobility-linked route when a time of travel using the vehicle from a congestion starting point where the congested section starts to the final destination is equal to or greater than a preset critical time. The route guiding server may be configured to search for an intermediate destination where the vehicle is able to be parked and the personal mobility is able to be used and provide the searched intermediate destination to the interface terminal, the intermediate destination may exists within a preset mobility travel distance from the final destination, and a time of travel using the personal mobility to the final destination may not exceed a preset mobility critical time.

The route guiding server may be configured to select an intermediate destination with a high priority when there area plurality of intermediate destinations, and the priority may be set based on a time required for traveling from the current location to the final destination through the intermediate destination, and the personal mobility rental probability for the personal mobility able to be used at the intermediate destination. The system may further include a mobility server that provides a mobility service through the personal mobility.

In one implementation, the mobility server may be configured to search for a mobility terminal of a personal mobility user that is within a certain radius from the intermediate destination, transmit the intermediate destination to the mobility terminal, receive handover approval of the personal mobility from the mobility terminal, and transmit the handover approval information and a travel route of the personal mobility to the interface terminal via the route guiding server. In addition, the mobility server may be configured to transmit information regarding the intermediate destination to a mobility terminal traveling toward the intermediate destination. In one implementation, mobility usage reservation of the user of the vehicle may be set for the personal mobility corresponding to the mobility terminal provided the handover approval information.

According to another aspect of the present disclosure, a method for guiding a route using a personal mobility may include receiving information regarding a current location and a final destination of a vehicle from an interface terminal of a user of the vehicle, and a route guidance operation of guiding a personal mobility-linked route based on information on traffic along a travel route from the current location to the final destination, a time required for travel based on the traffic information, and a personal mobility rental probability.

### BRIEF DESCRIPTION OF THE DRAWINGS

The above and other objects, features and advantages of the present disclosure will be more apparent from the following detailed description taken in conjunction with the accompanying drawings:

FIG. 1 is a control block diagram of a vehicle route guiding system according to an exemplary embodiment of the present disclosure;

FIG. 2 is a control flowchart for illustrating a method for recommending a personal mobility-linked route according to an exemplary embodiment of the present disclosure;

FIG. 3 is a control flowchart for illustrating a method for selecting an intermediate destination according to an exemplary embodiment of the present disclosure;

FIG. 4 is a diagram illustrating an example of selecting an intermediate destination according to an exemplary embodiment of the present disclosure;

FIG. 5 is a diagram for illustrating a vehicle route guiding method using personal mobility according to an exemplary embodiment of the present disclosure; and

FIG. 6 is a diagram for illustrating personal mobility linkage according to an exemplary embodiment of the present disclosure.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Furthermore, control logic of the present disclosure may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/of” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Hereinafter, some exemplary embodiments of the present disclosure will be described in detail with reference to the exemplary drawings. In adding the reference numerals to the components of each drawing, it should be noted that the identical or equivalent component is designated by the identical numeral even when they are displayed on other drawings. Further, in describing the exemplary embodiment of the present disclosure, a detailed description of the related known configuration or function will be omitted when it is determined that it interferes with the understanding of the embodiment of the present disclosure.

In describing the components of the exemplary embodiment according to the present disclosure, terms such as first, second, A, B, (a), (b), and the like may be used. These terms are merely intended to distinguish the components from other components, and the terms do not limit the nature, order or sequence of the components. Unless otherwise defined, all terms including technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

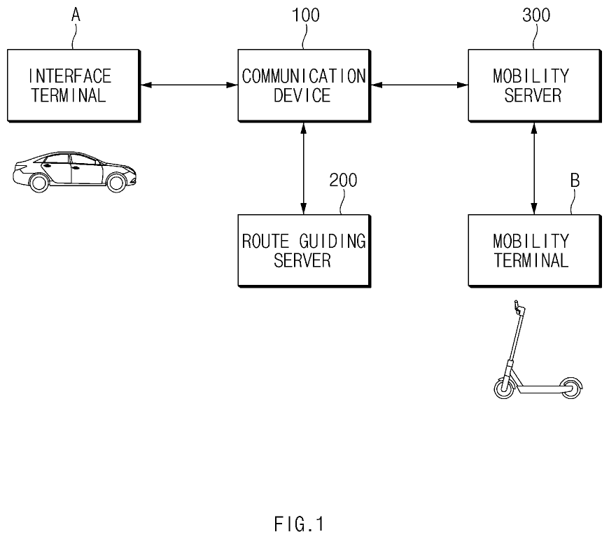

Hereinafter, with reference to FIGS. 1 to 6, exemplary embodiments of the present disclosure will be described in detail. FIG. 1 is a control block diagram of a vehicle route guiding system using a personal mobility according to an exemplary embodiment of the present disclosure. As shown, a vehicle route guiding system according to the present exemplary embodiment may include a communication device 100 configured to communicate with an interface terminal A of a user of a vehicle, a route guiding server 200 configured to provide guidance to a vehicle regarding a route toward a destination, and a mobility server 300 configured to provide a mobility service through personal mobility.

The communication device 100 may be responsible for communication with the route guiding server 200 and the mobility server 300 as well as the interface terminal A. The communication device 100 may be configured to perform communication between the servers 200 and 300 and data transmission and reception between terminals A and B and the servers 200 and 300 using all known communication methods.

The interface terminal A may be implemented as a terminal providing a direct user interface to a driver using the vehicle. For example, the interface terminal A may be implemented as a navigation terminal attachable to or installable in the vehicle, a mobile phone, or a personal PC. In other words, the interface terminal A may include all electronic devices on which a specific application is installed and executed, and including a display that may display a travel route of the vehicle and an input/output device that allows the user to input and select a specific signal.

The mobility terminal B may be implemented as a user interface that may be mounted on the personal mobility to display data received from the mobility server 300, and may be implemented as a mobile device, such as the interface terminal A, that may execute an application through which the user may communicate with the mobility server 300 to receive the mobility service. When information about a current location and a final destination of the vehicle is received from the interface terminal A, the route guiding server 200 may be configured to provide guidance for a personal mobility-linked route based on information on traffic along the travel route from the current location to the final destination, a time required for travel based on the traffic information, and a personal mobility rental probability. The route guidance by the route guiding server 200 will be described with reference to drawings below.

The mobility server 300 may be configured to provide the mobility service via the personal mobility such as an electric kick board, and may be configured to communicate with the mobility terminal B that may be utilized by a user of the personal mobility. The mobility server 300 may be configured to search a location of the personal mobility, search and manage rental and reservation statuses of the personal mobility, communicate with the route guiding server 200 according to an exemplary embodiment, and transmit and receive the location information and information on rental and handover of the personal mobility with the user.

The route guiding server 200 and the mobility server 300 may further include a database (not shown) for storing and processing various types of data. Alternatively, the vehicle route guiding system may include a separate data server. The route guiding server 200 and the mobility server 300 may be independent individual servers managed by different administrators. For example, the route guiding server 200 may be a server operated by a vehicle manufacturing company or a vehicle management company that provides various services related to the vehicle or the route guidance, and the mobility server 300 may be a management company that operates the reservation, the rental, and the management of the personal mobility.

Hereinafter, a control process through the route guiding server 200 and the mobility server 300 may be performed by an application capable of transmitting and receiving data and executing the data through communication between each of the servers 200 and 300, the interface terminal A, and the mobility terminal B. In one example, the route guiding server 200 may be configured to automatically search for the personal mobility-linked route when the user selects the final destination. When the user explicitly requests the guidance of the personal mobility-linked route, the route guiding server 200 may be configured to search for the same.

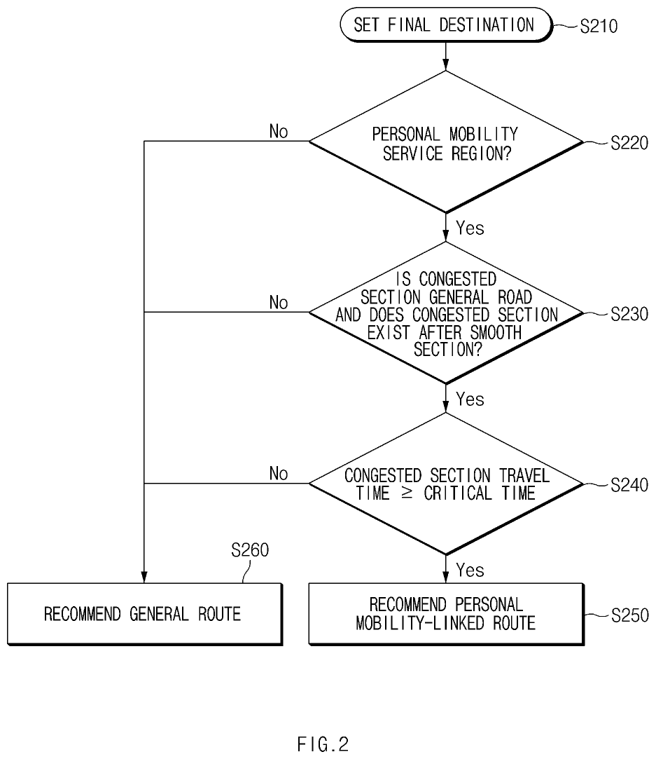

FIG. 2 is a control flowchart for illustrating a method for recommending a personal mobility-linked route according to an exemplary embodiment of the present disclosure. As shown, when the user of the vehicle sets the final destination (S210), the route guiding server 200 may be configured to determine whether the final destination is within a service region in which the personal mobility may be used (S220).

In response to determining that the final destination is within the service region in which the personal mobility may be used as a result of the determination, the route guiding server 200 may be configured to identify a smooth section in which the vehicle travels smoothly (e.g., without traffic) and a congested section in which the travel of the vehicle is stagnant of the travel route from the current location to the final destination based on the traffic information, and may be configured to determine whether the congested section is a general road and/or whether the congested section exists after the smooth section (S230). In other words, when the congested section is an expressway or a highway, operation of the personal mobility may be restricted. Therefore, a road corresponding to the congested section is the general road rather than the highway to move through the congested section using the personal mobility.

Further, when there is the congested section exists in a portion from the smooth section with smooth traffic to the final destination of a recommended route, which is one of usual route guidance, utilization of the personal mobility may be increased. Therefore, the route guiding server 200 may be configured to determine whether the congested section exists after the smooth section. When there is the congested section after the smooth section as a result of the determination, the route guiding server 200 may be configured to determine whether a time of travel using the vehicle from a congestion starting point at which such congested section starts to the final destination is equal to or greater than a preset critical time (S240).

In other words, whether the time of travel using the vehicle is equal to or greater than the critical time, for example, about 30 minutes may be determined. When the time of travel using the vehicle from the congestion starting point to the final destination is equal to or greater than about 30 minutes, the route guiding server 200 may be configured to recommend the personal mobility-linked route (S250). In one example, when the final destination is not within the service region in which the personal mobility may be used, and when the congested section is not the general road, the smooth section exists after the congested section, or the congested section travel time is less than the critical time, the route guiding server 200 may be configured to provide a general recommended route to the user (S260). In another example, when there is a request from the user, the route guiding server 200 may be configured to search for and recommend the personal mobility-linked route even when the smooth section exists after the congested section.

Further, the critical time for the time of travel using the vehicle from the congestion starting point to the final destination may be set by the user. The user may modify a value set as a default value to the desired critical time. Such critical time may be individually set depending on the route or the user, and a modification history may be stored.

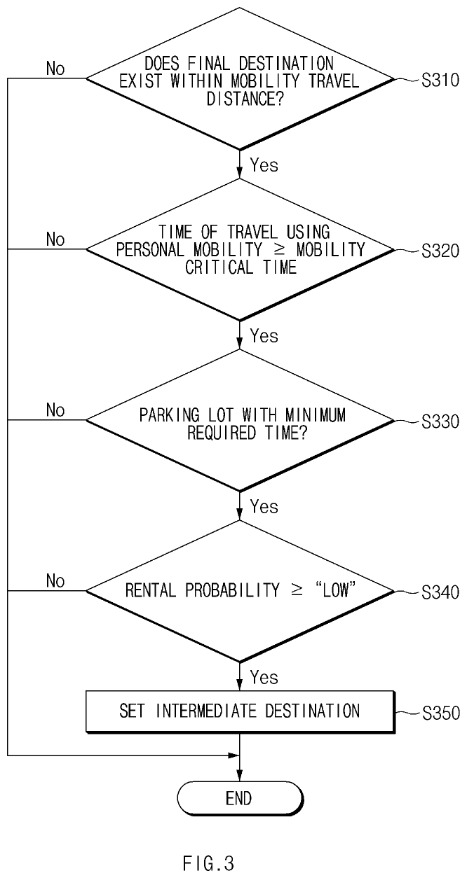

FIG. 3 is a control flowchart for illustrating a method for selecting an intermediate destination according to an exemplary embodiment of the present disclosure. When the recommendation of the personal mobility-linked route is set as shown in FIG. 2, the route guiding server 200 may be configured to search for and set an intermediate destination to allow the user to move through the smooth section using the vehicle and use the personal mobility in the congested section.

The intermediate destination may be a specific point, such as a parking lot, where the vehicle of the user may be parked, and may include an arbitrary point, such as the point at which the congested section starts after passing through the smooth section, where the vehicle may be parked and the personal mobility may be used. According to an example, the intermediate destination may be selected only when a condition that the intermediate destination is within a preset mobility travel distance from the final destination set by the user, and a condition that a time of travel using the personal mobility to the final destination does not exceed a preset mobility critical time are satisfied.

As shown in FIG. 3, the route guiding server 200 may be configured to search for the intermediate destination within the preset mobility travel distance from the final destination, for example, the parking lot within about 3 km from the final destination. In other words, the route guiding server 200 may be configured to determine whether the intermediate destination is within the mobility travel distance, which is not difficult to travel using the personal mobility (S310).

When the intermediate destination within the mobility travel distance from the final destination is searched as a result of the determination, the route guiding server 200 may be configured to determine whether the time of travel using the personal mobility from the intermediate destination to the final destination is equal to or greater than the mobility critical time (S320). For example, the mobility critical time may be set as a value between 10 and 30 minutes, and such critical time may also be set by the user.

When intermediate destinations, for example, parking lots satisfying the above two conditions are searched, the route guiding server 200 may be configured to set priorities for the plurality of parking lots, and select and recommend a parking lot with a high priority. Such priorities may be set based on a time required for traveling from the current location to the final destination through the intermediate destination, and a personal mobility rental probability for personal mobility that may be used at the intermediate destination.

For example, the route guiding server 200 may be configured to select a parking lot requiring the least time among the plurality of searched parking lots (S330). Then, whether a rental probability for the selected parking lot is equal to or greater than a preset “low” level may be determined (S340). In this connection, the rental probability is a grade of the number of personal mobility that may be rented in the parking lot. For example, when the number of personal mobility that may be rented is 1 to 3, the rental probability may be set to “low”, when the number of personal mobility that may be rented is 4 to 6, the rental probability may be set to “medium”, and when the number of personal mobility that may be rented is equal to or greater than 7, the rental probability may be set to “high”.

When a rental probability of the parking lot selected as a parking lot with the minimum required time has a grade equal to or greater than “low”, the route guiding server 200 may be configured to set the corresponding parking lot as the intermediate destination (S350). When a difference in the required time is equal to or less than 10 minutes, which is an insignificant difference, the route guiding server 200 may be configured to select a parking lot with a higher rental probability as the intermediate destination.

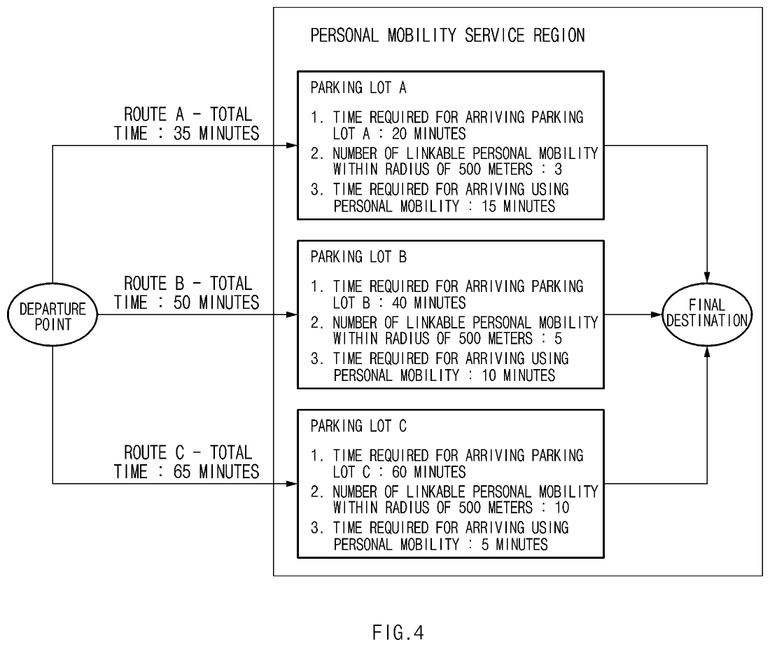

FIG. 4 is a diagram illustrating an example of selecting an intermediate destination according to an exemplary embodiment of the present disclosure. As shown, it may be assumed that three parking lots are searched in the personal mobility service region among routes from a departure point to the final destination. It takes a total of about 35 minutes of the travel time for a route A that passes through a parking lot A, it takes a total of about 50 minutes of the travel time for a route B that passes through a parking lot B, and it takes a total of about 65 minutes of the travel time for a route C that passes through a parking lot C.

When selecting the intermediate destination with reference to FIG. 3, the parking lot A may be finally recommended since there is the highest priority on the required time. In one example, when the priority is given to the rental probability according to another example, the route guiding server 200 may be configured to search for a parking lot route having the rental probability equal to or greater than “medium”, and in this case, the parking lot B may be selected. In other words, a weight for the priority may be changed based on a situation, and this may also be set by the user.

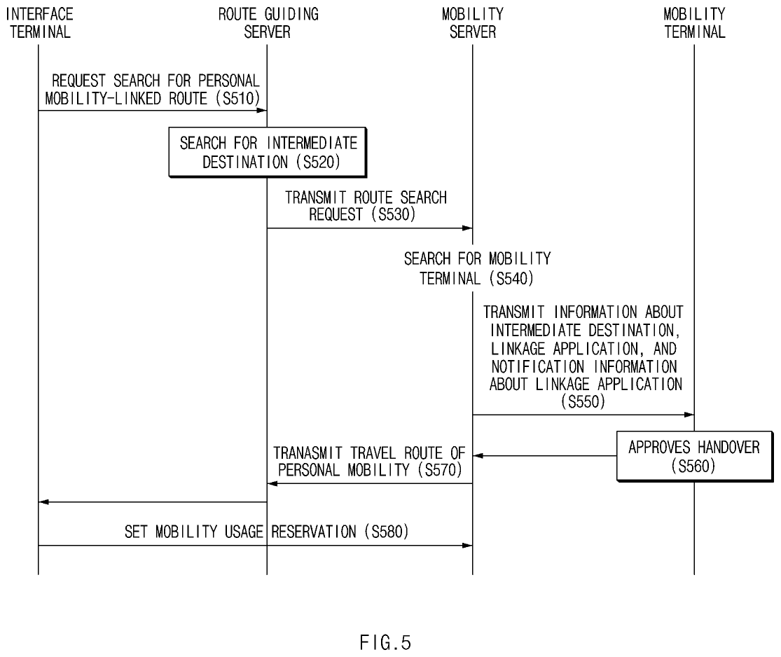

FIG. 5 is a diagram for illustrating a vehicle route guiding method using personal mobility according to an exemplary embodiment of the present disclosure. FIG. 5 shows input and output of signals between each of the servers 200 and 300 and the terminals A and B after a personal mobility linkage application by the user. A route guiding method according to the present exemplary embodiment is summarized as follows with reference to FIG. 5.

First, the search for the personal mobility-linked route may be requested through the interface terminal A (S510). When such the route search is requested, the intermediate destination may be searched by the route guiding server 200 as shown in FIGS. 2 and 3 described above (S520). Further, the route guiding server 200 may be configured to transmit the route search request to the mobility server 300 (S530), and the mobility server 300 may be configured to search for personal mobility and/or the mobility terminal B of a personal mobility user existing within a certain radius from the intermediate destination (S540).

The mobility server 300 may be configured to transmit information about the intermediate destination, the linkage application, and notification information about the linkage application to the searched mobility terminal B (S550). The notification information about the linkage application may be transmitted to the personal mobility. When the personal mobility is being operated by the user, the user may immediately recognize the linkage application.

The mobility server 300 may be configured to transmit information about the intermediate destination to the mobility terminal traveling toward the intermediate destination. In other words, even when there is the personal mobility or the mobility terminal B within the certain radius, the linkage request is not made unless the personal mobility or the mobility terminal B travels toward the intermediate destination. When the mobility terminal B approves the handover of the personal mobility (S560), handover approval information and a travel route of the personal mobility may be transmitted to the interface terminal A through the mobility server 300 and/or the route guiding server 200 (S570).

The travel route of the personal mobility may be displayed on a vehicle travel guide image such as a navigation on the interface terminal A Thereafter, mobility usage reservation of the user of the vehicle may be set for personal mobility corresponding to the mobility terminal B, which provided the handover approval information (S580). In other words, personal mobility approved the linkage application is reserved by the vehicle user. Thereafter, the corresponding personal mobility is not able to be reserved by another person.

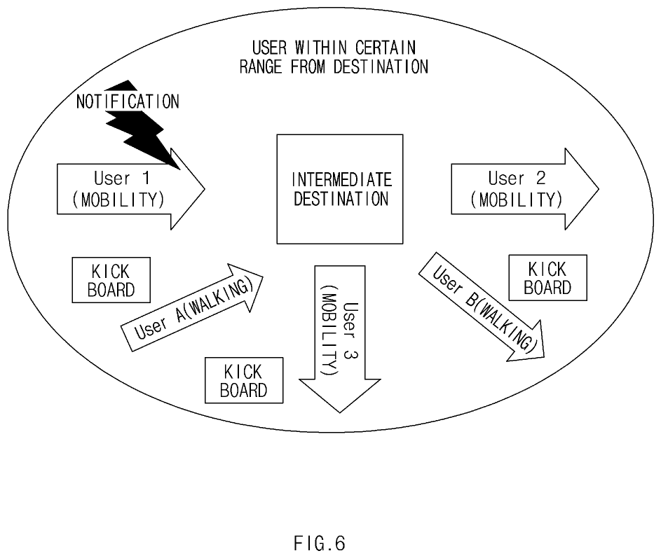

FIG. 6 is a diagram for illustrating personal mobility linkage according to an exemplary embodiment of the present disclosure. Personal mobility users within a certain range from the intermediate destination may be searched by the mobility server 300. As shown, as the users, there may be a USER 1, a USER 2, and a USER 3 who are currently boarding the personal mobility, and there may be a USER A and a USER B, who is not boarding the personal mobility and is likely to use the personal mobility.

Among these, the mobility server 300 may be configured to transmit a notification signal to the personal mobility with the user on board, and transmit the intermediate destination information and the linkage request information only to the USER 1 and the USER A traveling toward the intermediate destination. The USER 1, who has approved the handover application, may return the personal mobility at the destination, and the vehicle driver may use the returned personal mobility.

When the USER 1 returns the personal mobility at the intermediate destination before the vehicle driver arrives, the vehicle driver may move to a point where the personal mobility is located, and restart and use the personal mobility. In this connection, a use time of the vehicle driver may start based on a time at which the USER 1 returned the personal mobility. When the USER 1 returns the personal mobility at the intermediate destination after the vehicle driver arrives at a destination, the vehicle driver may receive the personal mobility as it is and then restart and use the personal mobility. In this connection, the use time of the vehicle driver may be configured to start at a time of receiving the personal mobility from the USER 1.

Further, when the USER 1 returns the personal mobility at the intermediate destination, some of an amount used may be returned when returning the personal mobility. Further, it may be determined that the vehicle driver uses the personal mobility from the time point at which the USER 1 returned the personal mobility. The vehicle driver may restart the personal mobility by taking a QR code with a registered terminal. In one example, information indicating that the mobility is available to the intermediate destination for free may be transmitted to the USER A. According to another example, the route guiding server 200 may be configured to request the mobility server 300 to search for the personal mobility and the mobility terminal B to search for the intermediate destination. In other words, the intermediate destination may be set based on the searched personal mobility and mobility terminal B.

As described above, the present disclosure provides the vehicle route guiding system and the route guiding method using the same capable of searching for the mobility information and communicating with the mobility user for the navigation route guidance through the linkage with the personal mobility. Further, the present disclosure provides the vehicle route guiding system using the personal mobility and the route guiding method using the same that propose the route for rapidly moving through the congested section.

The description above is merely illustrative of the technical idea of the present disclosure, and various modifications and changes may be made by those skilled in the art without departing from the essential characteristics of the present disclosure. Therefore, the exemplary embodiments disclosed in the present disclosure are not intended to limit the technical idea of the present disclosure but to illustrate the present disclosure, and the scope of the technical idea of the present disclosure is not limited by the embodiments. The scope of the present disclosure should be construed as being covered by the scope of the appended claims, and all technical ideas falling within the scope of the claims should be construed as being included in the scope of the present disclosure.

An exemplary embodiment of the present disclosure provides the system and the method capable of providing the navigation route guidance through the linkage with the personal mobility. Further, an exemplary embodiment of the present disclosure provides the vehicle route guiding system and the route guiding method using the same capable of searching for the mobility information and communicating with the mobility user to use the personal mobility.

An exemplary embodiment of the present disclosure provides the vehicle route guiding system using the personal mobility and the route guiding method using the same that propose the route for rapidly moving through the congested section. Further, an exemplary embodiment of the present disclosure provides the vehicle route guiding system and the route guiding method using the same capable of moving the personal mobility to the intermediate destination that may be linked with the vehicle. In addition, various effects that are directly or indirectly recognized through the present document may be provided.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A system for guiding a route using a personal mobility, comprising:
a communication device configured to communicate with an interface terminal of a user of a vehicle; and
a route guiding server configured to guide the vehicle along a personal mobility-linked route based on information on traffic on a travel route from a current location to a final destination, a time required for travel based on the traffic information, and a personal mobility rental probability when information about the current location and the final destination of the vehicle is received from the interface terminal.

2. The system of claim 1, wherein the route guiding server is configured to:
determine whether the final destination exists in a service region where the personal mobility is able to be used; and
guide the personal mobility-linked route when the final destination exists in the service region.

3. The system of claim 2, wherein the route guiding server is configured to:
determine a smooth section where the vehicle travels smoothly and a congested section where the travel of the vehicle is stagnant of the travel route based on the traffic information; and
guide the personal mobility-linked route when the congested section is a general road.

4. The system of claim 3, wherein the route guiding server is configured to guide the personal mobility-linked route when the congested section exists after the smooth section on the travel route.

5. The system of claim 4, wherein the route guiding server is configured to guide the personal mobility-linked route when a time of travel using the vehicle from a congestion starting point where the congested section starts to the final destination is equal to or greater than a preset critical time.

6. The system of claim 5, wherein the route guiding server is configured to
search for an intermediate destination where the personal mobility is able to be used and provide the searched intermediate destination to the interface terminal,
wherein the intermediate destination exists within a preset mobility travel distance from the final destination, and
wherein a time of travel using the personal mobility to the final destination does not exceed a preset mobility critical time.

7. The system of claim 6, wherein the route guiding server is configured to select an intermediate destination with a high priority when there are a plurality of intermediate destinations, wherein the priority is set based on a time required for traveling from the current location to the final destination through the intermediate destination, and the personal mobility rental probability for the personal mobility able to be used at the intermediate destination.

8. The system of claim 6, further comprising:
a mobility server configured to provide a mobility service through the personal mobility,
wherein the mobility server is configured to:
search for a mobility terminal of a personal mobility user existing within a certain radius from the intermediate destination;
transmit the intermediate destination to the mobility terminal;
receive handover approval of the personal mobility from the mobility terminal; and
transmit the handover approval information and a travel route of the personal mobility to the interface terminal through the route guiding server.

9. The system of claim 8, wherein the mobility server is configured to transmit information on the intermediate destination to a mobility terminal traveling toward the intermediate destination.

10. The system of claim 9, wherein mobility usage reservation of the user of the vehicle is set for the personal mobility corresponding to the mobility terminal provided the handover approval information.

11. A method for guiding a route using a personal mobility, comprising:
receiving, by a controller, information on a current location and a final destination of a vehicle from an interface terminal of a user of the vehicle; and
a route guidance operation of providing guidance along a personal mobility-linked route based on information on traffic along a travel route from the current location to the final destination, a time required for travel based on the traffic information, and a personal mobility rental probability.

12. The method of claim 11, wherein the route guidance operation includes:
determining whether the final destination exists in a service region where the personal mobility is able to be used; and
wherein the personal mobility-linked route is guided when the final destination exists in the service region.

13. The method of claim 12, wherein the route guidance operation includes:
determining a smooth section where the vehicle travels smoothly and a congested section where the travel of the vehicle is stagnant of the travel route based on the traffic information,
wherein the personal mobility-linked route is guided when the congested section is a general road.

14. The method of claim 13, wherein the route guidance operation includes:
guiding the personal mobility-linked route when the congested section exists after the smooth section on the travel route.

15. The method of claim 14, wherein the route guidance operation includes:
guiding the personal mobility-linked route when a time of travel using the vehicle from a congestion starting point where the congested section starts to the final destination is equal to or greater than a preset critical time.

16. The method of claim 15, wherein the route guidance operation includes:
searching for an intermediate destination where the personal mobility is able to be used and providing the searched intermediate destination to the interface terminal,
wherein the intermediate destination exists within a preset mobility travel distance from the final destination, and
wherein a time of travel using the personal mobility to the final destination is less than a preset mobility critical time.

17. The method of claim 16, wherein the route guidance operation includes:
selecting an intermediate destination with a high priority when there are a plurality of intermediate destinations,
wherein the priority is set based on a time required for traveling from the current location to the final destination through the intermediate destination, and the personal mobility rental probability for the personal mobility able to be used at the intermediate destination.

18. The method of claim 16, wherein the route guidance operation includes:
searching for a mobility terminal of a personal mobility user existing within a certain radius from the intermediate destination;
transmitting the intermediate destination to the mobility terminal;
receiving handover approval of the personal mobility from the mobility terminal; and
transmitting the handover approval information and a travel route of the personal mobility to the interface terminal.

19. The method of claim 18, wherein the transmitting of the intermediate destination includes:
transmitting information on the intermediate destination to a mobility terminal traveling toward the intermediate destination.

20. The method of claim 19, further comprising:
setting mobility usage reservation of the user of the vehicle for the personal mobility corresponding to the mobility terminal provided the handover approval information.
